(19) United States
(12) Patent Application Publication
(10) Pub. No.: US 2007/0082620 A1
(43) Pub. Date: Apr. 12, 2007

(54) METHOD AND APPARATUS FOR CONTROLLING UPLINK TRANSMISSION POWER FOR OFDMA BASED EVOLVED UTRA

(75) Inventors: Guodong Zhang, Farmingdale, NY (US); Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/537,784

(22) Filed: Oct. 2, 2006

Related U.S. Application Data
(60) Provisional application No. 60/724,441, filed on Oct. 6, 2005.

(51) Int. Cl. H04B 7/00; H04B 1/00

(52) U.S. Cl. 455/69; 455/522

(57) ABSTRACT

A method and apparatus for controlling uplink transmission power control of signals transmitted from a wireless transmit/receive unit (WTRU) to a serving base station in a packet-switched data based system having a plurality of neighbor cells. The path loss of neighbor interfering cells is measured by the WTRU and uplink interference measurements received from the neighbor interfering cells are monitored. The WTRU sends an uplink transmission request to the serving base station which includes a pilot signal and an uplink transmission power adjustment parameter computed by the WTRU. The serving base station performs a channel quality indicator (CQI) measurement of the pilot signal included in the uplink transmission request and determines the uplink transmission power of at least one of an uplink shared control channel and an uplink shared data channel established between the WTRU and the serving base station using the CQI and the uplink transmission power adjustment parameter.

### CROSS REFERENCE TO RELATED APPLICATION

This application claims the benefit of U.S. Provisional Application No. 60/724,441 filed Oct. 6, 2005, which is incorporated by reference as if fully set forth.

### FIELD OF INVENTION

The present invention is related to a wireless communication system including a base station and at least one wireless transmit/receive unit (WTRU). More particularly, the present invention is related to uplink transmission power control for evolved universal terrestrial radio access (UTRA), which may be applicable to a single carrier frequency division multiple access (SC-FDMA) based system or an orthogonal frequency division multiple access (OFDMA) based system.

### BACKGROUND

In order to keep the technology competitive for a much longer time period, both Third Generation Partnership Project (3GPP) and 3GPP2 are considering implementing long term evolution (LTE), in which evolution of a radio interface and network architecture are necessary.

Currently, SC-FDMA and OFDMA are being considered for the implementation of the uplink of evolved UTRA. Packet-switched data should be supported efficiently in evolved UTRA. Uplink data is transmitted on a shared channel. Therefore, the uplink transmission is not necessarily continuous, (in time). A properly designed uplink transmission power control (TPC) mechanism is needed to support this.

For a universal mobile telecommunications system (UMTS) wideband code division multiple access (WCDMA) uplink channel, a conventional closed-loop TPC mechanism is used. The conventional closed-loop TPC mechanism requires the history of uplink transmission power, and adjusts the uplink transmission power based on TPC commands received from cells/base stations. However, the conventional closed-loop TPC mechanism cannot handle packet-switched data due to the discontinuous transmission. With discontinuous transmissions, the previous transmission power may be meaningless.

### SUMMARY

The present invention is related to a method and apparatus for controlling uplink transmission power control of signals transmitted from a WTRU to a serving base station in a packet-switched data based system having a plurality of neighbor cells. The path loss of neighbor interfering cells is measured by the WTRU and uplink interference measurements received from the neighbor interfering cells are monitored. The WTRU sends an uplink transmission request to the serving base station which includes a pilot signal and an uplink transmission power adjustment parameter computed by the WTRU. The serving base station performs a channel quality indicator (CQI) measurement of the pilot signal included in the uplink transmission request and determines the uplink transmission power of at least one of an uplink shared control channel and an uplink shared data channel established between the WTRU and the serving base station using the CQI and the uplink transmission power adjustment parameter.

### BRIEF DESCRIPTION OF THE DRAWINGS

A more detailed understanding of the invention may be had from the following description, given by way of example and to be understood in conjunction with the accompanying drawings wherein:

FIG. 1 is a flowchart of a process of implementing TPC of an uplink channel in a wireless communication system in accordance with the present invention; and

FIG. 2 is an exemplary block diagram of the wireless communication system in which the process of FIG. 1 is implemented.

### DETAILED DESCRIPTION OF THE PREFERRED EMBODIMENTS

Hereafter, a wireless transmit/receive unit (WTRU) includes but is not limited to a user equipment (UE), a mobile station, a fixed or mobile subscriber unit, a pager, or any other type of device capable of operating in a wireless environment. When referred to hereafter, a base station includes but is not limited to a Node-B, a site controller, an access point (AP) or any other type of interfacing device in a wireless environment.

The features of the present invention may be incorporated into an integrated circuit (IC) or be configured in a circuit comprising a multitude of interconnecting components.

Due to the fact that packet-switched data transmission may be discontinuous, the proposed uplink transmission power control for evolved UTRA should be able to work without the history of transmission power.

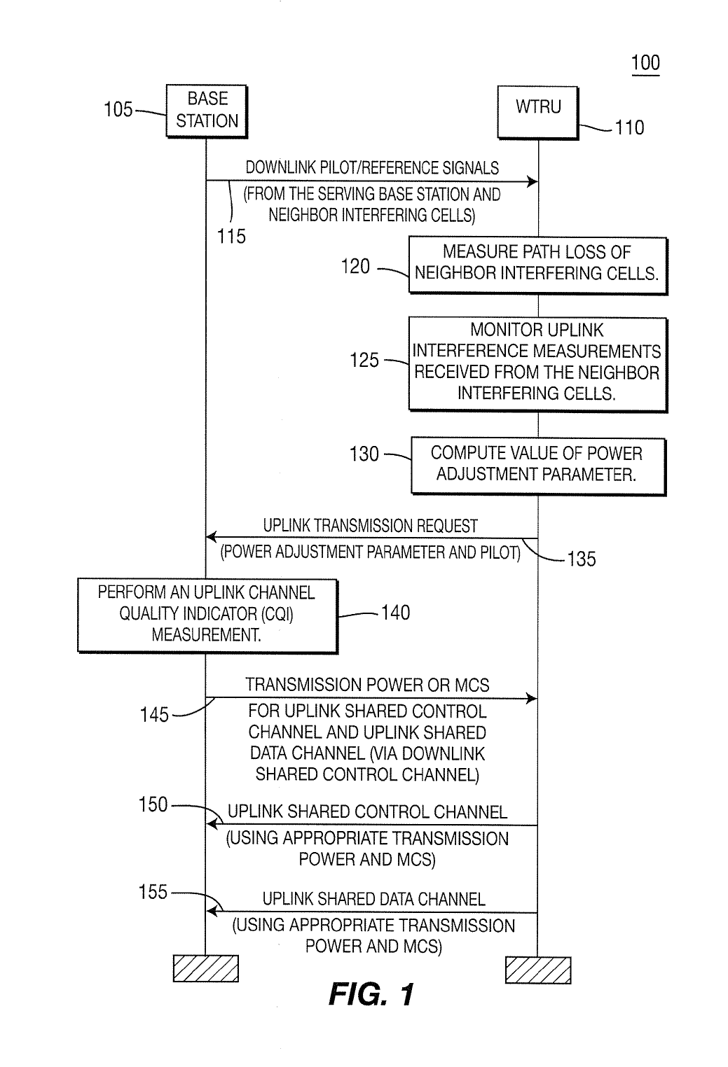

FIG. 1 is a flowchart of a process of implementing the TPC of an uplink shared control and data channel in a wireless communication system in accordance with the present invention. The wireless communication system includes a base station 105 and at least one WTRU 110.

Each cell always estimates the total or average amount of uplink interference in the cell. An interference measurement is performed for the entire uplink or for each radio chunk. Each cell broadcasts its uplink interference measurements via a broadcast channel (BCH) to WTRUs residing in other cells. Each broadcast uplink interference measurement may be represented in one or several bits. For example, a broadcast uplink interference measurement, denoted by UI, may be expressed in one bit. If the uplink interference exceeds a threshold, set UI=1; otherwise, set UI=0.

In step 115 of the process 100 of FIG. 1, each WTRU 110 receives downlink pilot/reference signals from the serving base station 105 and neighbor interfering cells. The neighbor interfering cells of a WTRU 110 are defined as the cells which the uplink of the WTRU 110 will be treated as intercell interference. If uplink intra-base station macro diversity is used in evolved UTRA, then the neighbor interfering cells of a WTRU 110 include all neighbor cells except the cells that are in the active set of the WTRU 110, (i.e., uplink soft handover of the WTRU 110 is performed in these cells). If uplink intra-base station macro diversity is not used in evolved UTRA, then the neighbor interfering cells of the WTRU 110 include all neighbor cells.

In step 120, each WTRU 110 measures the downlink pilot strength, (corresponding to the path loss), of each neighbor interfering cell. In step 125, each WTRU 110 monitors uplink interference measurements received from the neighbor interfering cells.

In step 130 of the process 100, the WTRU 110 determines a power adjustment value according to the broadcast uplink interference measurement of a neighbor interfering cell having the lowest path loss. For example, if the uplink interference measurement is expressed in one bit, the value of the power adjustment parameter is set to zero if the broadcast uplink interference measurement of the neighbor interfering cell with the lowest path loss is equal to 0. The value of the power adjustment parameter is set to a fixed positive number if the broadcast uplink interference measurement of the neighbor interfering cell with the lowest path loss is equal to 1.

Alternatively, the value of the power adjustment parameter is increased by a fixed number (Δᵤₚ) each time the broadcast uplink interference measurement of the neighbor interfering cell with the lowest path loss is equal to 1. The value of the power adjustment parameter is decreased by a fixed number (Δ_{down}) each time the broadcast uplink interference measurement of the neighbor interfering cell with the lowest path loss is equal to 0. However, the value of the power adjustment parameter is never decreased to a value less than zero.

Still referring to FIG. 1, the WTRU 110 transmits an uplink transmission request to the base station 105 to request uplink channel resources (step 135). The uplink transmission request includes the power adjustment parameter of the WTRU 110 and at least one pilot (i.e., reference signal), for performing a CQI measurement for scheduling and adaptive modulation and coding (AMC) for the uplink shared data channel transmission. In step 140, the base station 105 performs an uplink CQI measurement on the pilots signal received from the WTRU.

In the case that uplink intra-base station macro diversity is used, the base station 105 may measure the CQI of the primary cell only. The primary cell of a WTRU 110 is defined as the cell which has the lowest uplink path loss or CQI for the WTRU 110. Alternatively, the primary cell of a WTRU 110 may be defined as the cell from which the WTRU 110 receives the uplink scheduling information.

In the case that uplink inter-base station macro diversity is used, the WTRU 110 transmits the uplink transmission request to the primary base station only. The primary base station of a WTRU with uplink inter-base station macro diversity is defined as the base station that controls the cell with the lowest uplink path loss or CQI for the WTRU 110. Alternatively, the primary base station of a WTRU 110 can be defined as the base station that controls the cell from which the WTRU 110 receives the uplink scheduling information. The primary base station may measure the CQI of only the cell controlled by the primary base station.

The base station 105 determines the transmission power of both an uplink shared control channel and an uplink shared data channel based on the measured CQI, (i.e., the path loss condition). The base station 105 adjusts the transmission power downward by the value of the power adjustment parameter sent by the WTRU 110 with the uplink transmission request. The base station 105 informs the WTRU 110 of a value the power adjustment parameter must be adjusted to via the downlink shared control channel. There are two options to implement this.

Option 1: The base station 105 sends the relative transmission power values, (relative to uplink pilot), for the uplink shared control channel and shared data channel via the downlink shared control channel to the WTRU 110 explicitly.

Option 2: The base station 105 does not send the relative transmission powers to the WTRU 110 explicitly. Instead, the base station 105 selects the modulation and coding set (MCS) for the uplink shared control channel and shared data channel accordingly. Then, the base station 105 informs the WTRU 110 of the MCS for the uplink shared control channel and the uplink shared data channel via the downlink shared control channel (step 145). Then, the WTRU 110 calculates the transmission powers of the uplink shared control channel and the uplink shared data channel by using a predetermined lookup table (LUT) provided by the base station 105 which denotes the relationship between the MCS and the required transmission power of the shared control signaling channel.

In both options 1 and 2, it may be redundant to send transmission power or MCS information for both the uplink shared control channel and the uplink shared data channel to the WTRU 110. Let P_{sc}, P_{sd} and Pₚᵢₗₒₜ denote the transmission power of the uplink shared control channel, the uplink shared data channel and the pilot, respectively. Let Pᵣₑₗₐₜᵢᵥₑ denote the relative transmission power. Let MCS_{sc} and MCS_{sd} denote the MCS used by the uplink shared control channel and the uplink shared data channel respectively. Let SNR(MCS_{sc}) and SNR(MCS_{sd}) denote required signal-to-noise ratio (SNR) of the MCS used by the uplink shared control channel and the uplink shared data channel respectively. In order to reduce the signaling overhead, the base station 105 may send only the transmission power or MCS information for the uplink shared control channel to the WTRU 110. Then, the WTRU 110 may derive the transmission power or MCS for the uplink shared data channel based on the transmission power or MCS information. For example,
P_{sc}=Pₚᵢₗₒₜ+Pᵣₑₗₐₜᵢᵥₑ; and Equation (1)
P_{sd}=P_{sc}+SNR(MCS_{sd})−SNR(MCS_{sc})+Margin, Equation (2)
where Margin is a design parameter.

In step 150 of the process 100 of FIG. 1, the WTRU 110 transmits the uplink shared control channel with the appropriate transmission power and MCS.

In step 155 of the process 100 of FIG. 1, the WTRU 110 transmits the uplink shared data channel with the appropriate transmission power and MCS.

In the case where there is only transmission on the uplink shared control channel but no transmission on the uplink shared data channel, the proposed uplink transmission power control mechanism my still be applied without the base station 105 sending any transmission power or MCS information relevant to the uplink shared data channel.

The present invention responds to fast fading without the history of the transmission power. Therefore, the present invention handles packet-switched traffic in evolved UTRA in an efficient and seamless manner.

The above method may be implemented in a WTRU or a base station at the physical layer on the digital baseband. Possible implementations include application specific integrated circuit (ASIC), digital signal processor (DSP), software and hardware. The applicable air interface includes 3GPP LTE.

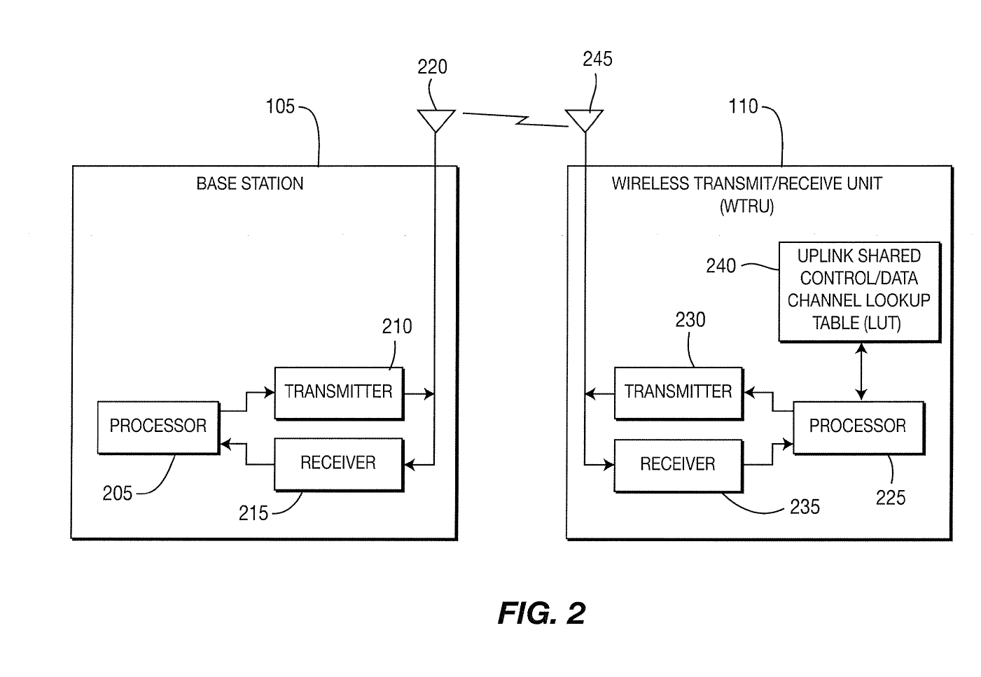

FIG. 2 is an exemplary block diagram of the wireless communication system in which the process 100 of FIG. 1 is implemented. The wireless communication system shown in FIG. 2 includes the base station 105 and at least one WTRU 110. The base station 105 includes a processor 205, a transmitter 210, a receiver 215 and an antenna 230. The WTRU 110 includes a processor 225, a transmitter 230, a receiver 235, an uplink shared control/data channel LUT 240 and an antenna 245.

The transmitter 210 in the base station 105 transmits a downlink pilot signal to the WTRU 110. The receiver 235 in the WTRU 110 receives the downlink pilot signal from the transmitter 210 and downlink pilot signals from neighbor interfering cells via the antenna 245. The processor 225 in the WTRU 110 measures the path loss of the neighbor interfering cells. The processor 225 in the WTRU 110 also monitors uplink interference measurements received by the receiver 235 from the neighbor interfering cells via the antenna 245 and determines the value of a power adjustment parameter accordingly.

The processor 225 of the WTRU 110 computes a value of a power adjustment parameter according to the broadcast uplink interference measurement of a neighbor interfering cell having the lowest path loss. The transmitter 230 of the WTRU 110 transmits an uplink transmission request to the base station 105 via the antenna 245 to request uplink channel resources. The uplink transmission request includes the power adjustment parameter of the WTRU 110 and at least one pilot for performing a CQI measurement for scheduling and AMC for the uplink shared data channel transmission.

The receiver 215 in the base station 105 receives the uplink transmission request from the WTRU 110, and the processor 205 of the WTRU 110 performs an uplink CQI measurement, and determines the transmission power of both an uplink shared control channel and an uplink shared data channel based on the measured CQI.

The processor 205 of the base station 105 controls the transmitter 210 to adjust the transmission power downward by the value of the power adjustment parameter sent by the WTRU 110 with the uplink transmission request.

Option 1: The transmitter 210 of the base station 105 sends the relative transmission powers (relative to uplink pilot) for the uplink shared control channel and shared data channel via the downlink shared control channel to the WTRU 110 explicitly.

Option 2: The processor 205 in the base station 105 selects the modulation and coding set (MCS) for the uplink shared control channel and shared data channel accordingly. Then, transmitter 210 in the base station 105 sends a downlink signal via the antenna 220 which informs the WTRU 110 of the MCS for the uplink shared control channel and the uplink shared data channel via the downlink shared control channel. When the receiver 235 receives the downlink signal via the antenna 245, the processor 225 in the WTRU 110 calculates the transmission powers of the uplink shared control channel and the uplink shared data channel by using a predetermined uplink shared control/data channel lookup table (LUT) 240 which denotes the relationship between the MCS and the required transmission powers of the uplink shared control channel and/or the uplink shared data channel.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method of controlling uplink transmission power of signals transmitted from at least one wireless transmit receive unit (WTRU) to a serving base station in a packet-switched data based system having a plurality of neighbor cells, the method comprising:
the WTRU receiving downlink pilot signals from the serving base station and the plurality of neighbor cells;
the WTRU receiving a plurality of uplink interference measurements from the neighbor cells;
the WTRU measuring the path loss of the neighbor cells based on the strength of the received downlink pilots;
the WTRU computing an uplink transmission power adjustment parameter based on the received uplink interference measurement of the neighbor cell having the lowest path loss;
the WTRU transmitting an uplink transmission request to the serving base station, the uplink transmission request including the power adjustment parameter and a pilot signal; and
the serving base station using the power adjustment parameter to reduce the power of uplink transmissions emitted from the WTRU to the serving base station.

2. The method of claim 1 further comprising:
measuring at the serving base station a channel quality indicator (CQI) of the pilot signal included in the uplink transmission request.

3. The method of claim 2 further comprising:
the serving base station sending a signal to the WTRU which includes information that indicates the transmission power of an uplink shared control channel established between the WTRU and the serving base station.

4. The method of claim 3 wherein the information includes a modulation and coding set (MCS) selected by the serving base station.

5. The method of claim 3 wherein the WTRU uses a predetermined lookup table which contains modulation and coding set (MCS) values and corresponding transmission power values to determine transmission power of the uplink shared control channel.

6. The method of claim 2 further comprising:
the serving base station sending a signal to the WTRU which includes information that indicates the transmission power of an uplink shared data channel established between the WTRU and the serving base station.

7. The method of claim 6 wherein the information includes a modulation and coding set (MCS) selected by the serving base station.

8. The method of claim 6 wherein the WTRU uses a predetermined lookup table which contains modulation and coding set (MCS) values and corresponding transmission power values to determine transmission power of the uplink shared data channel.

9. The method of claim 1 wherein the value of the uplink transmission power adjustment parameter is based on the interference of the neighbor cell having the lowest path loss.

10. The method of claim 2 wherein intra-base station macro diversity is used for the uplink signal and interfering neighbor cells include all neighbor cells except cells that are in an uplink active set for the WTRU.

11. The method of claim 2 wherein intra-base station macro diversity is used for the uplink signal such that the CQI measurement is performed only for a cell having the lowest path loss.

12. The method of claim 2 wherein intra-base station macro diversity is used for the uplink signal such that the CQI measurement is performed only for a cell in which the WTRU resides.

13. The method of claim 2 wherein inter-base station macro diversity is used for the uplink signal and the uplink transmission request is sent to the serving base station having the lowest uplink path loss.

14. The method of claim 2 wherein inter-base station macro diversity is used for the uplink signal and the uplink transmission request is sent to the serving base station which controls the cell in which the WTRU resides.

15. A wireless transmit receive unit (WTRU) comprising:
a receiver for (i) receiving a plurality of downlink pilots from a plurality of neighbor interfering cells, (ii) receiving a plurality of uplink interference measurements from the neighbor interfering cells, and (iii) receiving a signal from a serving base station which reduces the power of uplink transmissions emitted from the WTRU to the serving base station;
a processor for measuring the path loss of the neighbor interfering cells based on the strength of the received downlink pilots and for computing an uplink transmission power adjustment parameter based on the received uplink interference measurement of the neighbor interfering cell having the lowest path loss; and
a transmitter for transmitting an uplink transmission request to the serving base station, the uplink transmission request including the power adjustment parameter, and for transmitting the uplink transmissions at a power level determined by the serving base station.

16. An integrated circuit (IC) embedded in a wireless transmit receive unit (WTRU), the IC comprising:
a receiver for (i) receiving a plurality of downlink pilots from a plurality of neighbor interfering cells, (ii) receiving a plurality of uplink interference measurements from the neighbor interfering cells, and (iii) receiving a signal from a serving base station which reduces the power of uplink transmissions emitted from the WTRU to the serving base station;
a processor for measuring the path loss of the neighbor interfering cells based on the strength of the received downlink pilots and for computing an uplink transmission power adjustment parameter based on the received uplink interference measurement of the neighbor interfering cell having the lowest path loss; and
a transmitter for transmitting an uplink transmission request to the serving base station, the uplink transmission request including the uplink power adjustment parameter, and for transmitting the uplink transmissions at a power level determined by the base station.
